(19) United States
(12) Patent Application Publication
(10) Pub. No.: US 2007/0095554 A1
(43) Pub. Date: May 3, 2007

(54) Explosion-proof enclosure

(75) Inventor: Eiichi Noda, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/540,618

(22) Filed: Sep. 29, 2006

(30) Foreign Application Priority Data
Sep. 30, 2005 (JP) 2005-287469

(51) Int. Cl. H01H 13/04

(52) U.S. Cl. 174/55

(57) ABSTRACT

It is an explosion-proof enclosure incorporating an apparatus. This explosion-proof enclosure includes an inner case configured to incorporate a general purpose apparatus and to have a withstand pressure that satisfies an explosion-proof standard, and an outer case provided to cover the inner case and to have a cover and a case body, which are configured so that a depth of the joint surface between the cover and the case body and a joint gap therebetween satisfy the explosion-proof standard.

### BACKGROUND OF THE INVENTION

The present invention relates to an explosion-proof enclosure that is lightweight and that is improved in design flexibility and general versatility. More particularly, the present invention relates to an explosion-proof case that enables the use of general-purpose equipment in a hazardous area.

The following related art document relates to an explosion-proof enclosure.

[Non-patent Document 1]

The homepage of Kabushiki Kaisha Nakamura Denki Seisakusho's website, which showed an explosion-proof structure personal computer system and is browsed on Sep. 21, 2005, on the Internet at the following URL: http://www.ex-nakamura.co.jp/product/pasocon/pasocon.html.

FIG. 2 is an explanatory view illustrating the configuration of a related explosion-proof enclosure that has hitherto been widely used.

As shown in FIG. 2, a personal computer A which is a general-purpose apparatus is incorporated in a case 1.

A cover 2 having a flange portion 3 is provided in an opening portion of the case 1.

Generally, an explosion-proof enclosure is designed under the following constraints.

The explosion-proof enclosure should have stiffness sufficient to resist explosive power generated due to an explosion occurring in the apparatus.

Explosion-proof standards stipulate that the joint area between the cover 2 and the case 1 should be large.

Explosion-proof standards stipulate that the gap between the cover 2 and the case 1 should be small.

In short, explosion-proof enclosures are strictly constrained by “technical standards” conforming to the international electrotechnical commission (IEC) standards.

To satisfy the “technical standards”, explosion-proof cases, which are made mainly of a metal by casting or die-casting, are widely used.

Such explosion-proof enclosures have the following problems.

Generally, an explosion-proof apparatus is designed for exclusive use. Therefore, a general-purpose apparatus cannot be used without change.

That is, to use general-purpose apparatuses in explosive areas, a case designed specifically for each of the apparatuses is needed.

Generally, as described above, the case is large in weight due to a metallic structure thereof. Thus, the design flexibility of the case is low.

As a result of the fact that “the design flexibility of the case is low”, the shape of the case is limited to, for example, a shape designed to be constituted by simple straight lines and also limited to that unsuitable for incorporating a general-purpose handy device formed so that the body thereof is integral with a large arcuate roundish handle.

### SUMMARY OF THE INVENTION

An object of the invention is to solve the aforementioned problems. Accordingly, an object of the invention is to provide a lightweight explosion-proof enclosure adapted to respectively assign required functions to the following two parts and also adapted to excel in design flexibility.

1. An outer case that is configured to ensure the joint area according to the standards and the gap between the cover and the case, and that is constituted by a material that excels in the design flexibility.

2. An inner case constituted by a material that is stiff sufficient to resist explosive power.

To achieve the foregoing object, according to aspect 1 of the present invention, there is provided an explosion-proof enclosure incorporating an apparatus, including: an inner case configured to incorporate a general-purpose apparatus and to have a withstand pressure that satisfies an explosion-proof standard; and an outer case provided to cover the inner case and to have a cover and a case body, which are configured so that a depth of a joint surface between the cover and the case body and a joint gap therebetween meet standard size requirements conforming to the explosion-proof standard.

According to aspect 2 of the present invention, there is provided the explosion-proof enclosure according to aspect 1, wherein an electrolytic zinc-coated carbon steel sheet material is used as a material of the inner case.

According to aspect 3 of the present invention, there is provided the explosion-proof enclosure according to aspect 1 or 2, wherein the outer case is made of a carbon fiber reinforced engineering plastic material.

The explosion-proof enclosure according to aspect 1 has the following advantages.

A lightweight explosion-proof enclosure, which excels in design flexibility, is obtained by respectively assigning functions required of the explosion-proof enclosure to the two parts.

Also, an explosion-proof enclosure enabled so that it is sufficient to change the design of the inner case even when the apparatus to be mounted in the enclosure is changed, and that the enclosure can be used without changing the design of the outer case and the external appearance thereof.

The explosion-proof enclosure according to aspect 2 has the following advantages.

Because an electrolytic zinc-coated carbon steel sheet material is used as the material of the inner case, the construction of the explosion-proof enclosure can be ensured so that a withstand pressure thereof satisfies requirements relating to explosive power which conforms to the explosion-proof standard.

The explosion-proof enclosure according to the aspect 3 has the following advantages.

Because the outer case is made of a carbon fiber reinforced engineering plastic material, the construction of the explosion-proof enclosure can easily be obtained so that the depth of the joint surface and the joint gap satisfy the explosion-proof standard. Also, a shape enabling the enhancement of the function of a handle and engravings of logos and explanatory characters can be formed at a time, so that a lightweight explosion-proof enclosure can be obtained

### BRIEF DESCRIPTION OF THE DRAWINGS

FIG. 1 is an explanatory view illustrating the configuration of a primary part of an embodiment of the invention.

FIG. 2 is an explanatory view illustrating the configuration of a related explosion-proof enclosure that has hitherto been widely used.

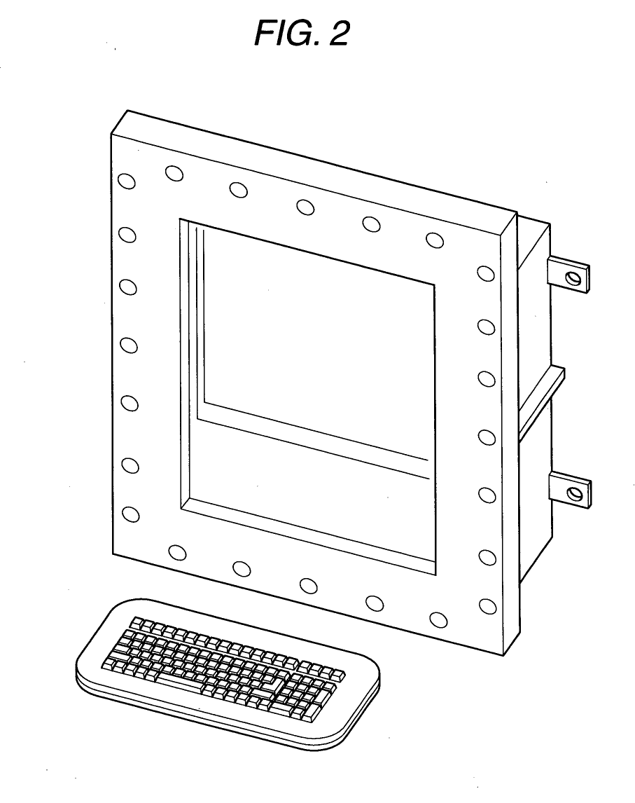

### DETAILED DESCRIPTION OF THE PREFERRED EMBODIMENTS

Hereinafter, an embodiment of the invention is described below in detail by referring to the accompanying drawings.

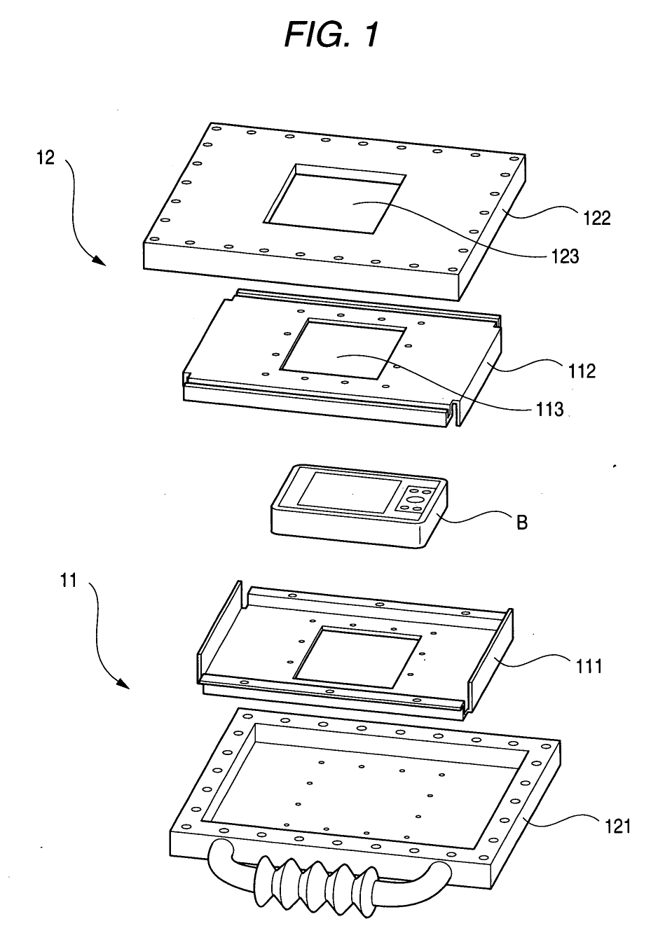

FIG. 1 is an explanatory view illustrating the configuration of a primary part of the embodiment of the invention and shows an example of an explosion-proof enclosure incorporating a handy device.

As shown in FIG. 1, the handy device B is incorporated in the inner case 11 whose withstand pressure satisfies an explosion-proof standard.

The inner case 11 has a case body 111 and a cover 112 thereof.

In this case, an electrolytic zinc-coated carbon steel sheet material is used as the material of the inner case 11.

In short, a high-strength material, whose withstand pressure thereof satisfies requirements relating to explosive power which conforms to the explosion-proof standard is used as the material of the explosion-proof enclosure.

Also, in this case, a window 113 made of a glass material is provided in the cover 112.

The inner case 11 is constituted by the rigid material that can stand explosive power generated in the explosion-proof enclosure. An optimal construction (or structure) with respect to the strength can be employed by ignoring an external appearance thereof.

The outer case 12 is provided to cover the inner case 11 and to have a case body 121 and a cover 122, which are configured so that a depth of the joint surface between the case body 121 and the cover 122 and the joint gap therebetween meet standard size requirements conforming to the explosion-proof standard.

In this case, a carbon fiber reinforced engineering plastic material is used as the material of the outer case 12.

More specifically, for example, a carbon fiber reinforced engineering plastic material including mainly a modified polyphenylene oxide (PPO) resin (Noryl®), a carbon fiber reinforced engineering plastic material including mainly a modified polycarbonate (PC) resin (Lexan®), or a carbon fiber reinforced engineering plastic material including mainly a polybutylene terephthalate (PBT) resin (VALOX®) is used as the material of the outer case 12.

In short, a material having a high design flexibility is used as the material of the outer case 12.

Also, in this case, a window 123 made of a glass material is provided in the cover 122.

The outer case 12 is formed to be thick so that the joint area and the joint gap meet the explosion-proof standard.

Thus, the volume of the outer case 12 increases. Unless the material of the outer case 12 is as light as possible, the weight of the outer case 12 is large.

Therefore, the weight of the outer case 12 can be suppressed by employing a light weight material, such as a plastic material.

Incidentally, a plastic material has a large flexibility in shape, as compared with steel. Thus, an explosion-proof enclosure, which excels in design flexibility, can be realized.

The inner case 11 is adapted to receive the explosive power, so that the deformation of the outer case 12 due to the explosive power is minimized. Thus, a lightweight material having high workability can be used as the material of the outer case 12.

Consequently, a lightweight explosion-proof enclosure, which satisfies the explosion-proof standard and excels in design flexibility, is obtained by respectively assigning functions required of the explosion-proof enclosure to the two parts.

Also, the present embodiment can obtain an inexpensive explosion-proof enclosure enabled so that it is sufficient to change the design of the inner case 11 even when the apparatus to be mounted in the enclosure is changed, and that the enclosure can be used without changing the design of the outer case 12 and the external appearance thereof.

Because an electrolytic zinc-coated carbon steel sheet material is used as the material of the inner case 11, the present embodiment can easily obtain a lightweight explosion-proof enclosure having a construction ensured so that a withstand pressure thereof satisfies requirements relating to explosive power which conforms to the explosion-proof standard.

Because the outer case 12 is made of a carbon fiber reinforced engineering plastic material, the construction of the explosion-proof enclosure can easily be obtained so that the depth of the joint surface and the joint gap satisfy the explosion-proof standard. Also, a shape enabling the enhancement of the function of a handle and engravings of logos and explanatory characters can be formed at a time, so that a lightweight explosion-proof enclosure can be obtained.

Incidentally, in the foregoing description of the embodiment, it has been described that the handy device B is incorporated in the enclosure. However, the apparatus incorporated in the enclosure is not limited thereto. Needless to say, a larger apparatus, for example, a general-purpose installation type apparatus may be incorporated therein.

Also, needless to say, to enhance assemblability, the enclosure may be formed so that the inner case 11 and the outer case 12 are integral with each other.

The metallic inner case 11 can be used as a wireless antenna. Also, an antenna may be provided at the side of the outer case 12 by making a hole in a part of the outer case 12.

The foregoing description shows only specific preferred embodiments for the purposes of illustration and exemplification of the invention. Accordingly, the invention is not limited thereto and further includes many changes and modifications without departing from the spirit and scope of the invention.

What is claimed is:

1. An explosion-proof enclosure incorporating an apparatus, comprising:
an inner case configured to incorporate a general-purpose apparatus and to have a withstand pressure that satisfies an explosion-proof standard; and
an outer case provided to cover the inner case and to have a cover and a case body, which are configured so that a depth of a joint surface between the cover and the case body and a joint gap therebetween meet standard size requirements conforming to the explosion-proof standard.

2. The explosion-proof enclosure according to claim 1, wherein
an electrolytic zinc-coated carbon steel sheet material is used as a material of the inner case.

3. The explosion-proof enclosure according to claim 1, wherein
the outer case is made of a carbon fiber reinforced engineering plastic material.

4. The explosion-proof enclosure according to claim 3, wherein
the carbon fiber reinforced engineering plastic material includes mainly a modified polyphenylene oxide (PPO) resin.

5. The explosion-proof enclosure according to claim 3, wherein
the carbon fiber reinforced engineering plastic material includes mainly a modified polycarbonate (PC) resin.

6. The explosion-proof enclosure according to claim 3, wherein
the carbon fiber reinforced engineering plastic material includes mainly a polybutylene terephthalate (PBT) resin.
